(19) United States
(12) Patent Application Publication
(10) Pub. No.: US 2010/0223676 A1
(43) Pub. Date: Sep. 2, 2010

(54) Device And Method For Publishing Multimedia Contents By Rendering Them Accessible To The Public

(75) Inventor: Daniele Belloli, Milano (IT)

Correspondence Address: Cozen O''''Connor, 277 PARK AVENUE, 20th Floor, NEW YORK, NY, 10172, US

(73) Assignee: CAPE CODE LTD, London (GB)

(21) Appl. No.: 12/440,275

(22) PCT Filed: Mar. 16, 2007
(86) PCT No.: PCT/EP2007/052508

§ 371 Date: Mar. 6, 2009

(30) Foreign Application Priority Data
Sep. 7, 2006 (IT) MI2006 A 001706

(51) Int. Cl. G06F 15/16; G06F 21/00

(52) U.S. Cl. 726/30; 709/219; 709/217

(57) ABSTRACT

The device for publishing multimedia contents by rendering them accessibility to the public comprises an electronic processor connected to publication units for multimedia contents. The electronic processor carries stored in its memory the multimedia contents to be published, and information relative to the dates and times of publication. The processor supports control software for controlling the publication of the multimedia contents via the publication unit on the set dates and times; first communication software for downloading online the information relative to the dates and times of publication; and second communication software for downloading online said multimedia contents to be published and/or their updating. The method enables publication of the multimedia contents via the publication unit on the set dates and times to be automatically commanded.

The present invention relates to a device and a method for publishing multimedia contents by rendering them accessibility to the public.

Traditionally, publicity messages are transmitted using vehicles such as artistic road, television or radio visualization to reach a wide spectrum of consumers.

However, with the passage of time it has been found that publicity aimed at a specific type of clientele is much more effective and enables information to be transmitted which is much more receptive to the consumer.

In this respect, certain large distribution chains (such as restaurants or shops) have formed their own dedicated publicity vehicles (for example dedicated radio and/or video channels) which transmit publicity messages aimed at the interior of their concerns and specifically created for customers who frequent determined localities (such as the restaurant where the transmission takes place) or have determined interests (such as where the transmission takes place for example within the shops of a large sports article chain).

However even these vehicles have demonstrated certain limitations.

Firstly, they can be used only by large chains able to create and manage a complex and costly dedicated transmission vehicle.

Small commercial concerns are excluded from this system both because of cost, and because of the limited visibility which in any event they would achieve by transmitting publicity messages exclusively within their own concern.

To also overcome this drawback and make dedicated publicity also available to small commercial concerns, systems have been proposed in which the publicity messages are memorized on physical supports such CDs or DVDs or another similar supports, and are supplied to said commercial concerns where they are transmitted (via audio and/or video).

However these systems are extremely rigid, because once the messages have been generated and supplied to the transmission points they cannot be further modified until the next release of new supports (for example until new CDs or DVDs have been despatched to the concerns implementing the system).

Moreover the costs of providing publicity in this manner are not negligible as a third operator has to be used to produce the physical supports (CDs or DVDs) containing the publicity messages to be transmitted, and to despatch them to the consignees.

The technical aim of the present invention is therefore to provide a device and method for publishing multimedia contents by rendering them accessibility to the public, which enable the stated technical drawbacks of the known art to be eliminated.

Within the scope of this technical aim, an object of the invention is to provide a device and method which enable publicity messages aimed at specific types of clientele to be transmitted using a substantially simple and economical transmission system.

Another object of the invention is to provide a device and system which enable high visibility to be given to all operators using it, independently of the number of concerns being owned (in the sense that to achieve high visibility it is not necessary to possess a large number of commercial concerns within which to transmit the publicity messages).

A further object of the invention is to provide a device and method which are very flexible and enable both the publicity messages and information relative to date, time, place or other publication characteristics to be updated very simply and quickly and with only a small time period (fixed beforehand) between the moment in which the modifications are made and the moment in which the modifications are implemented.

The technical aim, together with these and other objects, are attained according to the present invention by a device and method for publishing multimedia contents by rendering them accessibility to the public, in accordance with the accompanying claims.

Other characteristics of the present invention are defined in the subsequent claims.

Advantageously, the device and method of the invention are particularly suitable for use by small shops or commercial concerns as they enable the publicity messages to be proposed to be prepared directly and online with the aid of suitable multimedia data banks; in this manner, messages with optimum audio/visual impact (of professional level) can be constructed simply and quickly without being multimedia technology experts.

In the same manner, information relative to date, time and place of publication can be handled directly.

Further characteristics and advantages of the invention will be more evident from the description of a preferred but non-exclusive embodiment of the device and method according to the invention, illustrated by way of non-limiting example in the accompanying drawings, in which:

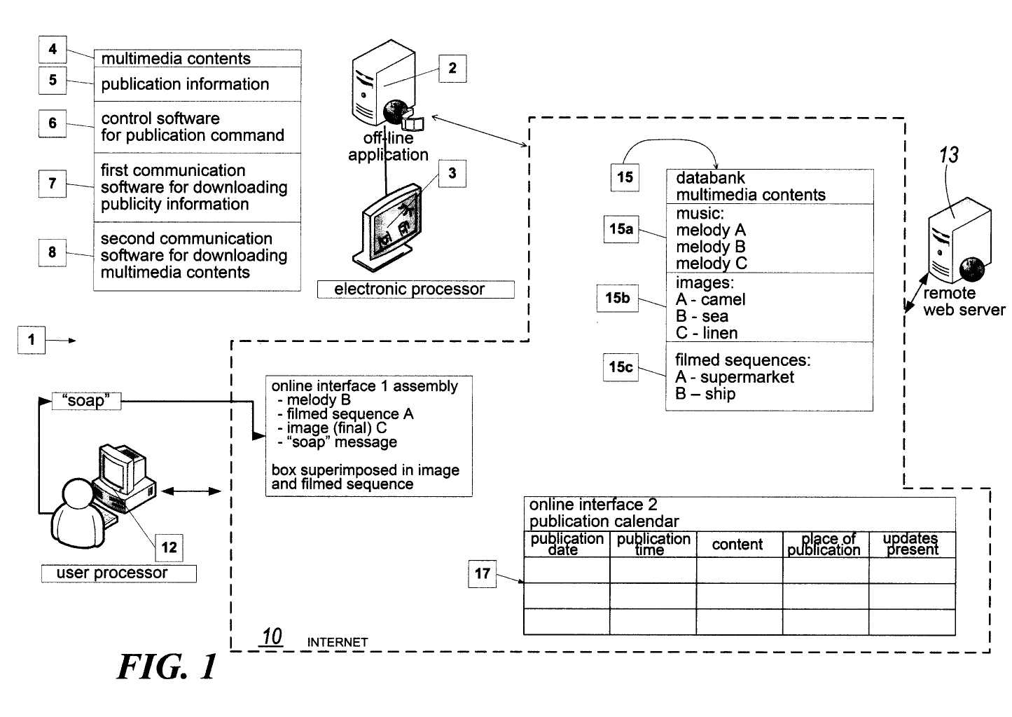

FIG. 1 shows an operating scheme of a device according to the present invention;

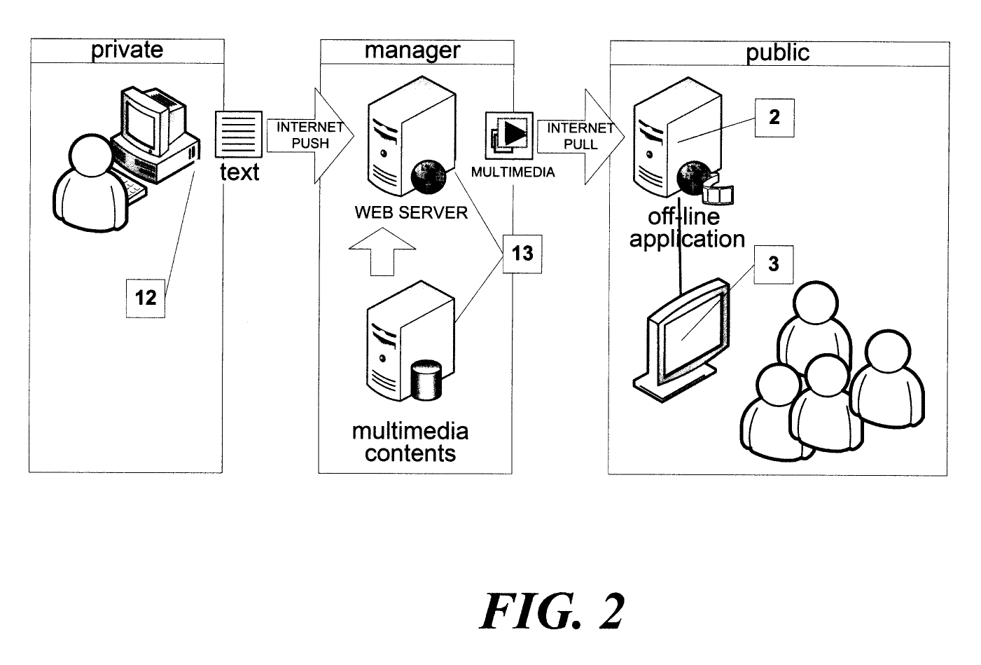

FIG. 2 shows a scheme representing three operative blocks of the device of the present invention;

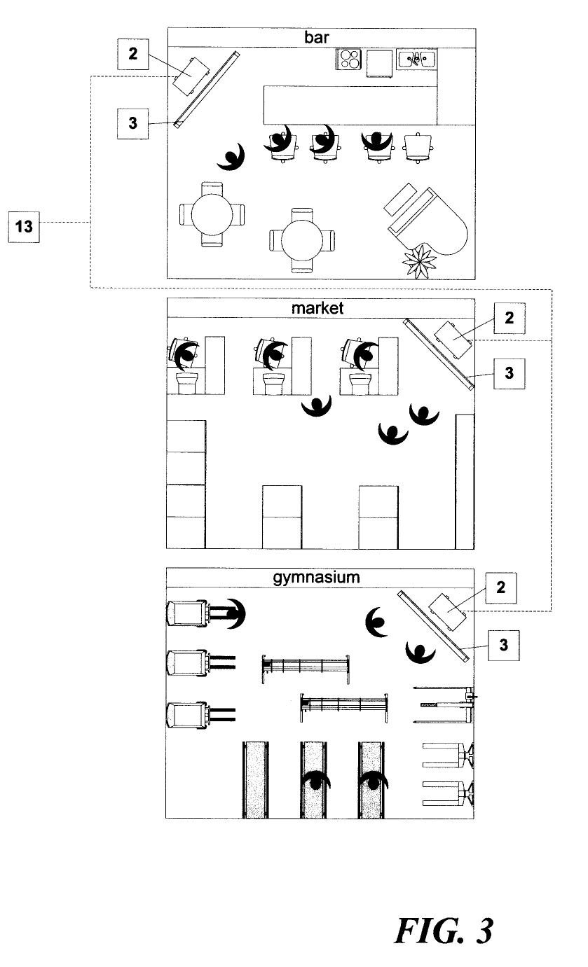

FIG. 3 shows a scheme of the invention implementing a publicity message transmission network;

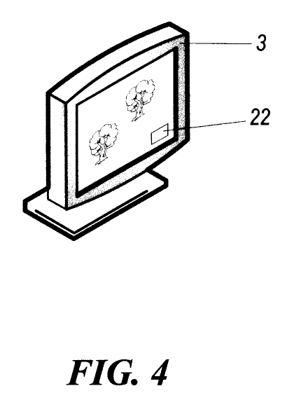

FIG. 4 shows a monitor provided with a sensor for verifying the publicity content;

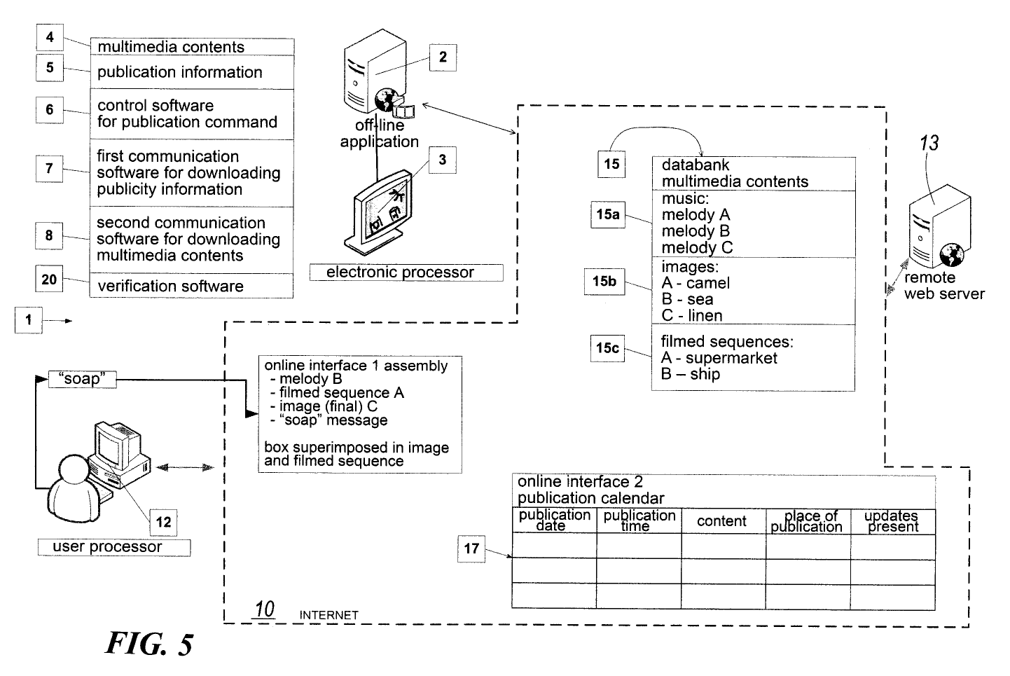

FIG. 5 shows a further embodiment of a scheme of the invention for implementing a publicity message transmission network.

With reference to said figures, these show a device for publishing multimedia contents by rendering them accessibility to the public, which is indicated overall by the reference numeral 1.

The device 1 comprises an electronic processor 2 connected to at least one publication unit 3 for the multimedia contents, which are in the form for example of audio/video filmed sequences or of fixed or moving texts superimposed on or displayed to the side of a television transmission or a recorded movie.

The electronic processor 2 carries stored in its memory both the multimedia contents 4 to be published, and a plurality of publication information 5 relative for example to the dates and times of publication of the multimedia contents.

The processor 2 also carries certain software for data transfer and for its own control.

In particular, the electronic processor 2 supports control software 6 for controlling the publication of the multimedia contents 4 via the publication unit 3 on the set date and time.

In the same manner the electronic processor 2 supports first communication software 7 for downloading online the information relative to the dates and times of publication of a particular multimedia content and second communication software 8 for downloading online the multimedia contents to be published and/or multimedia content updates.

Typically the publication unit comprises a monitor (for example a high definition television screen); in this manner the device comprises very common components easily obtainable commercially at relatively low cost.

The electronic processor 2 can also be connected, via the internet 10, to a user processor 12 and to a remote server 13 supporting a first databank 15 of multimedia contents; reference will be made hereinafter to a remote server, however it is evident that the remote server can be physically implemented as two or more devices (such as PC or server) connected together physically or operatively (as shown in FIG. 2).

For example the databank 15 can contain musical files 15a for use as soundtracks in publicity messages or for integrating visual messages with audio messages, files 15b containing fixed images (such as photographs) or files 15c containing filmed sequences.

The user processor 12 can access the first databank 15 online and select the multimedia contents for publication, which are to be transmitted by the electronic processor 2.

Preferably, the remote server 13 supports assembly software for assembling the multimedia contents (selected from the databank 15) to be published.

For example this assembly software consists of:
a catalogue of complete text creations and multimedia contents which can be scanned and filtered according to search criteria;
a preview page reproducing the creations exactly as published to enable the user to fully comprehend the result obtained;
a graphic interface allowing intuitive modification of part or all of to the creation chosen from the catalogue, to adapt it to user requirements. The modifications made can be viewed on the preview page;
a graphic interface optionally enabling personal multimedia contents to be uploaded for addition to the creation, such as product logos and images;
an instrument for saving, archiving and opening executed jobs, enabling the user to save and reload partially completed or completed jobs and make subsequent advancements.

As the assembly software has to operate on the user processor 12, which preferably does not have specific provisions on board, this software is completely in the form of an internet application.

In this manner (by means of this software) the non-expert is also able to alone create (i.e. without the aid of experts) winning messages with optimum multimedia characteristics.

Preferably the assembly software is able to insert into the assembled multimedia contents strings of text or other multimedia contents transmitted by the user processor 12.

The remote server 13 supports a second databank 17 containing information relative to publication dates, time and places.

This databank 17 is accessible by the first software such that the electronic processor is able to download at least the information relative to the publication dates and times of determined multimedia contents.

The second databank 17 is also accessible by the user processor 12 to modify this information.

In this manner each user can set within the databank 17 the information relative to the publication of determined multimedia contents, after which the processor 2 downloads at least the information relative to the publication dates and times.

In a preferred embodiment (FIG. 3), the device comprises a plurality of electronic processors 2 each associated with a publication unit 3 such as to define a plurality of local units positionable in places accessible to the public, such as places of refreshment, connectable to the remote server 13 and to the user processor 12, without however requiring a continuous connection.

In particular, the first software is arranged to download information relative to the publication dates and times, and the second software to download the multimedia contents to be published only for local units positioned in places selected as places of publication.

In this manner each local unit can display, at any moment, messages different from those displayed by the other local units.

The second software transmits creation components effectively different from those already present on the electronic processor 2 instead of entire creations, for example to personalize the creations present on the processor 2; in this manner, assuming that the user adds only text to the model chosen from the catalogue, the quantity of data required during updating is reduced and narrow band connections can be used, to considerably enlarge the potential number of places of publication.

Moreover these messages can (in known manner) be represented on a flat screen, superimposed on other representations (for example TV, etc.), side by side, etc.

In a further embodiment (FIG. 5), the device is provided with a verification system for the multimedia content.

In this respect, the electronic processor 2 supports software 20 enabling the multimedia content displayed by one or more (generally all) of the publication units 3, or a signal indicative of this multimedia content, to be viewed.

This software 20 implements a menu, for example of the dropdown type, form which a screen can be accessed showing that being published by one or more (generally all) of the publication units, or a message indicative of the content being published.

This is implemented in a first embodiment (FIG. 4) by reserving usually a corner area to a signal uniquely indicative of the content being published; this signal is preferably a coloured light signal.

A light sensor 22 also able to detect colours is applied in said reserved area on the monitor 3.

In this manner each content is published together with the coloured light signal; this latter coloured light signal is sensed by the sensor, which generates an electric signal transmitted to the electronic processor 2, where it is interpreted by the software 20, which indicates the content associated with that light signal.

Advantageously, the light sensor is very economical and of very small dimensions, but provides high accuracy in colour sensing.

Other types of signal could also be associated with the contents, for example bar codes.

In a further example, the software 20 can show directly that displayed on the monitor 3; this can be achieved by an external video camera which films the monitor 3 (and hence that shown on it) or by transmitting the audio/video signal fed by the electronic processor 2 to an image acquisition card of the same electronic processor 2.

The software 20 is also able to display the second databank 17 either totally or partially; for example a choice can be made between either making only future publications accessible to an individual requesting them, or only those publications made by the same individual requesting them, but not those made or to be made by other individuals.

The operation of the device of the invention is apparent from that described and illustrated, and is substantially as follows.

In the following example it will be assumed that the device comprises a plurality of local units (i.e. numerous electronic processors 2 each connected to its own television screen 3) arranged within shops or commercial premises of a district or town (FIG. 3), a user perhaps being a concern wishing to publicize a product or service offered by that concern.

The user previously connects to the remote server 13 via the user processor 12 (consisting of a PC available to the user, which does not require any particular software).

When the user processor 12 has been connected to the remote server 13, the multimedia message to be published is created via the first interface.

Assuming a publicity message relative to a soap is to be created, the user could select from the databank 15 the melody B, the filmed sequence A (supermarket) and the image C (household linen, which could be used as the closure image of the multimedia publicity message).

Then, again via the first interface, the user executes the assembly software and combines the various files, superimposing sound on the images, cutting those parts of the filmed sequence or images which may not be of interest, superimposing filmed sequence parts on each other or on the selected image, etc.

The user then transmits via the processor 12 a string of text to be represented in the multimedia message; in this respect, the user could key into the user processor 12 the message “soap” and feed it to the remote server 13; this step can evidently be bypassed.

Using the assembly software the user selects where the string of text is to appear, for example superimposed on images as if forming part of them, or on headline characters, etc.

At this point, the step of preparing the multimedia message can be considered concluded, the user then saving the resultant multimedia message on the remote server 13.

The user can then access the second interface to select places of publication and publication dates and times.

The user preferably chooses places in which individuals interested in the products or services offered thereby are to be found.

In the preceding soap example, as places the user could select hairdressers, bakeries or small food stores and, in general, those places (in which local units have been installed) where housewives are presumably to be found.

The user could evidently select merely the places of publication, on the dates and times desired by the user if these are not already occupied by other individuals; this service (online booking) could be subject to payment of a minimum sum.

In addition, following each booking the remote server is able to advantageously issue a receipt indicating the place and times of publication.

When the publication data (places, dates and times) have been selected the user can disconnect the user processor from the server.

Periodically (for example every night and at preset times of the day) all the electronic processors 2 are connected to the server to update their information; this enables electronic processors to be used outside private LAN or WAN networks, and enables the network of places of publication to be economically and easily extended on a worldwide level.

The transmitted contents can be minimally reduced to just the personal components (inserted text and publication dates and times), because the multimedia components are updated separately on the processors 2 at rarer intervals; this enables narrow band connections to be also effectively used.

The connection can be made either simultaneously for all processors 2 or for groups of processors 2 in order not to overload the transmission lines.

When this connection is made, each electronic processor 2 (identified by the place of publication) reads from the databank 17 the new messages to be downloaded (to then be published) or the messages already in its possession which have been modified and downloads them via the second software, moreover it acquires the publication dates and times.

In this manner each electronic processor 2 holds in its memory the data relative to the multimedia messages to be published and the information relative to the publication dates and times, periodically updating all this information.

When updating is terminated the processors 2 are disconnected from the remote server, and at the scheduled dates and time transmit the last multimedia message downloaded by them.

Advantageously, each electronic processor 2 downloads only those publicity messages to be published, as the user selects from the databank 17 those places of publication which identify each processor 2 where the user wishes its own message to be published and hence where it is downloaded.

The present invention also relates to a method for publishing multimedia contents by rendering them accessibility to the public.

The method consists of transmitting online to an electronic processor connected to a multimedia content publication unit:
the multimedia contents which are to be published; and
information relative to at least the dates, times and places of publication of the multimedia contents;

and automatically commanding publication of the multimedia contents via the publication unit on the set dates and times.

Preferably the multimedia contents to be transmitted to the electronic processor are produced or updated by selecting from the multimedia contents available in the first databank of the remote server and assembling these multimedia contents, then inserting into the assembled multimedia contents strings of text or other multimedia contents transmitted by the user processor.

The information relative to dates, times and places of publication are stored in the second databank of the remote server. This information can be modified on access to the remote server by the user processor via the second interface.

In a particular embodiment, the method enables the published multimedia content to be verified.

Verification takes place by viewing the multimedia content displayed by one or more (generally all) of the publication units 3 or a signal indicative of this multimedia content.

Advantageously, the device and method of the invention can be used to transmit promotional messages by persons (for example political messages) or to broadcast projects (for example for humanitarian or political purposes).

In addition, the device and method of the invention enable personal messages to be broadcast, for example messages by persons seeking a companion or persons seeking other individuals having the same interests or hobbies.

In a further example, the device and method of the invention can be used to broadcast creative activities.

For example an artist such as a painter can decide to publish his/her creations (i.e. in the present example the paintings prepared by him/her).

In this case the multimedia data bank contains multimedia contents enabling a virtual museum to be formed.

The artist has therefore to form his/her own museum from the multimedia contents available in the databank 15 (including in relation to the works which he is about to exhibit) and then upload onto the remote server 13 from his/her own user processor 12 the images of the pictures prepared by him/her (the pictures must evidently be digital or have been suitably photographed or otherwise acquired such as to obtain a digital image usable by the device of the invention).

Again in this case assembly can be achieved via the available assembly software.

In the same manner different artistic forms can be used, for example music (in which case sound files are processed), poetry or prose (in which case text files are processed), etc.

Hence in this case the user uploads from the user processor 12 to the remote server 13 not merely strings of text but more complex (and bulky) messages generally of multimedia type.

The “exhibition” is made accessible only in those places chosen by the artist and for time periods defined by the artist, consequently in one and the same place in which the service is delivered, the representation may consist for example of an exhibition of pictures at 7 pm, a concert at 9 pm and a poetry presentation at 11 pm.

In these latter cases (broadcasting of messages for promotion of persons or creative activity or the like), the remote server 13 is advantageously able to provide information relative to that to be published at subsequent dates and times.

In a further example, the publication unit for multimedia contents is a television station; in this case the programme schedule is downloaded by the transmitter and transmitted over the airways.

The television station is particularly of digital type, providing up to 8 channels for a currently existing analogue channel.

Hence a thematic channel could be provided for web-derived contents self-produced by users; such television channels could transmit social messages of various types; in particular a community user could transfer a message into the system, edit it to add whatever may be lacking, then choose the transmission time, with a television transmitter as the place (in addition to bars).

It has been found in practice that the device and method of the invention are particularly advantageous as they enable the non-expert to publish multimedia publicity messages at low cost and with high audiovisual impact, with considerable flexibility in choosing and modifying the publication information and the multimedia message itself.

The device and method conceived in this manner are susceptible to numerous modifications and variants, all falling within the scope of the inventive concept; moreover all details may be replaced by technically equivalent elements.

1. A device for publishing multimedia contents by rendering them accessibility to the public, comprising an electronic processor connected to at least one publication unit for said multimedia contents, characterised in that said electronic processor carries stored in its memory:
the multimedia contents to be published, and
information relative at least to the dates and times of publication of said multimedia contents;
said processor also supporting:
control software for controlling the publication of said multimedia contents via the publication unit on the set dates and times;
first communication software for downloading online the information relative to the dates and times of publication; and
second communication software for downloading online said multimedia contents to be published and/or updates of said multimedia contents.

2. A device as claimed in claim 1, characterised in that said publication unit comprises a monitor.

3. A device as claimed in one or more of the preceding claims, characterised in that said electronic processor can be connected, via the internet, to a user processor and to a remote server supporting a first databank of multimedia contents, the user processor being able to access said first databank and select the multimedia contents for publication, which are to be transmitted to the electronic processor.

4. A device as claimed in one or more of the preceding claims, characterised in that said remote server supports assembly software for assembling the multimedia contents to be published.

5. A device as claimed in one or more of the preceding claims, characterised in that said assembly software is able to insert into the assembled multimedia contents strings of text or other multimedia contents transmitted by said user processor.

6. A device as claimed in one or more of the preceding claims, characterised in that said remote server supports a second databank containing said information relative to publication dates, time and places and accessible by said first software, said second databank being accessible by said user processor to modify this information.

7. A device as claimed in one or more of the preceding claims, characterised by comprising a plurality of electronic processors each associated with a publication unit such as to define a plurality of local units position able in places accessible to the public, such as places of refreshment, and connectable to the remote server and to the user processor, without requiring a continuous connection.

8. A device as claimed in one or more of the preceding claims, characterised in that said first software is arranged to download information relative to the publication dates and times and multimedia contents to be published only for local units positioned in places selected as places of publication.

9. A device as claimed in one or more of the preceding claims, characterised in that the second software is arranged to download the multimedia contents to be published only for local units positioned in places selected as places of publication.

10. A device as claimed in one or more of the preceding claims, characterised by being provided with a verification system for the published multimedia content.

11. A device as claimed in one or more of the preceding claims, characterised in that said verification system comprises software supported by the electronic processor to enable the multimedia content displayed by one or more of the publication units, or a signal indicative of this multimedia content, to be viewed.

12. A device as claimed in one or more of the preceding claims, characterised by having reserved an area for a signal, consisting of a coloured light signal, uniquely indicative of the content being published; on said reserved area of the monitor there being applied a light sensor able to sense colours, such that each content is published together with the coloured light signal; this latter coloured light signal being sensed by the sensor, which generates an electric signal transmitted to the electronic processor, where it is interpreted by the software, which indicates the content associated with that light signal.

13. A device as claimed in one or more of the preceding claims, characterised in that the verification software is able to display the second databank either totally or only partially.

14. A device as claimed in one or more of the preceding claims, characterised in that the remote server is able to provide information relative to that to be published at subsequent dates and times.

15. A device as claimed in one or more of the preceding claims, characterised in that the publication unit for the multimedia contents is a television station of digital type.

16. A method for publishing multimedia contents by rendering them accessibility to the public, characterised by consisting of transmitting online to an electronic processor connected to a multimedia content publication unit:
the multimedia contents which are to be published; and
information relative to at least the dates, times and places of publication of the multimedia contents;
and automatically commanding publication of said multimedia contents via the publication unit on the set dates and times.

17. A method as claimed in the preceding claim, characterised by producing or updating the multimedia contents to be transmitted to the electronic processor by selecting from the multimedia contents available in the first databank of a remote server and assembling these multimedia contents.

18. A method as claimed in claim 16, characterised by inserting into the assembled multimedia contents strings of text and/or other multimedia contents transmitted by a user processor.

19. A method as claimed in one or more of claims 16 and onwards, characterised by saving the formed message on the remote server.

20. A method as claimed in one or more of claims 16 and onwards, characterised in that the information relative to dates, times and places of publication are stored in a second databank of the remote server, said information being modifiable by access to the remote server by the user processor via the second interface.

21. A method as claimed in one or more of claims 16 and onwards, characterised in that the user can select merely the places of publication, on the dates and times desired by the user if these are not already occupied by other individuals.

22. A method as claimed in one or more of claims 16 and onwards, characterised in that all the electronic processors are connected periodically to the server to update their information.

23. A method as claimed in one or more of claims 16 and onwards, characterised by enabling the published multimedia content to be verified.

24. A method as claimed in one or more of claims 16 and onwards, characterised in that verification takes place by viewing the multimedia content displayed by one or more of the publication units or a signal indicative of this multimedia content.

25. A method as claimed in one or more of claims 16 and onwards, characterised by making the content of the second databank totally or partially accessible.
